(19) United States
(12) Patent Application Publication
(10) Pub. No.: US 2017/0116314 A1
(43) Pub. Date: Apr. 27, 2017

(54) INTEGRATING REAL-TIME NEWS WITH HISTORIC EVENTS

(71) Applicant: Google Inc., Mountain View, CA (US)

(72) Inventors: Adrian Aoun, Seattle, WA (US); Michele Banko, Seattle, WA (US); Guido Bartolucci, Seattke, WA (US); Erik Frey, Seattle, WA (US)

(21) Appl. No.: 13/936,526

(22) Filed: Jul. 8, 2013

Related U.S. Application Data
(63) Continuation of application No. 13/231,637, filed on Sep. 13, 2011, now abandoned.
(60) Provisional application No. 61/382,364, filed on Sep. 13, 2010.

(51) Int. Cl. G06F 17/30

(52) U.S. Cl. CPC G06F 17/30598

(57) ABSTRACT

A method for enhancing data consumption is disclosed. An indication of an interest in an item of a data feed is received. One or more entities associated with the item are identified. Here, the entities are structures into which portions of the item are capable of being categorized. One or more data types of the one or more entities are identified. A template is selected from a set of templates based on the one or more data types. Here, each one of the set of templates specifies a visualization of information associated with the data item. A visualization is presented based on the template.

### CROSS-REFERENCE TO RELATED APPLICATIONS

This application is a continuation of U.S. patent application Ser. No. 13/231,637, filed on Sep. 13, 2011, which claims the benefit of U.S. Provisional Application Ser. No. 61/382,364, filed on Sep. 13, 2010, the entirety of which are incorporated by reference.

### TECHNICAL FIELD

The present application relates generally to the technical field of finding, organizing, and presenting data and, in one specific example, to presenting, based on interests of a person, a graphical representation of an aggregation of multiple items from multiple Internet data feeds.

### BACKGROUND

Data feeds, including news and other textual Web data, may be published online at a high rate. The proliferation of Web content may make it challenging for users (or consumers) of the data feeds to easily glean information from the vast repository of available text, both past and present.

### BRIEF DESCRIPTION OF THE DRAWINGS

FIG. 1 is a block diagram depicting an example embodiment of a system to enhance a consumption of a data feed.

FIG. 2 is a flowchart of an example embodiment of a method to enhance a consumption of a data feed.

FIG. 3 is a flowchart of an example embodiment of a method to enhance a consumption of a data feed.

FIG. 4 is a flowchart of an example embodiment of a method to enhance a consumption of a data feed.

FIG. 5 is a flowchart of an example embodiment of a method to enhance a consumption of a data feed.

FIG. 6 is a block diagram illustrating an example environment in which a system to enhance the consumption of a data feed may execute.

FIG. 7 is a block diagram of machine in the example form of a computer system within which instructions, for causing the machine to perform any one or more of the methodologies discussed herein, may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, well-known instruction instances, protocols, structures, and techniques have not been shown in detail. As used herein, the terms “and” and “or” may be construed in an inclusive or exclusive sense. Additionally, the term “user” may be construed as a person or a machine.

In order to accommodate the modern Web user's information needs, a goal may be to store, explore and visualize news and other textual Web data in a manner that is “compatible with the Web.” An example method to accomplish this goal may include one or more of the following operations:

Encapsulating the essence of an article by identifying the who, what, when, and where describing a news event;

Eliminating redundancy of information present within similar articles, while retaining interesting differences in reporting (e.g., different prices reported for a corporate acquisition or speculations behind a celebrity break-up);

Supporting processing and display of continuous content updates;

Enabling users to re-visit historical data relative to items and events mentioned in an article (e.g., the current American president is meeting with the leader of Iran. Which other U.S. presidents previously visited Iran and why?);

Enabling users to explore related data (e.g., “Two famous musicians are reportedly dating. What other celebrity couples are rumored to exist?”); or

Visualizing events detected within large volumes of data using simple, familiar interfaces.

By representing news and other online articles as structured data, the example method may enable efficient storage, search and discovery over large volumes of text. The method may take as a given that information-extraction techniques, which identify entities and events within freeform text and produce structured data items, are already available. Accordingly, the method may focus solely on requirements to facilitate or enhance a search or a display of structured news items (e.g., by integrating real-time news with historic events).

In various embodiments, systems and methods for enhancing data consumption are disclosed. An indication of an interest in an item of a data feed is received. One or more entities associated with the item are identified. Here, the entities are structures into which portions of the item are capable of being categorized. One or more data types of the one or more entities are identified. A template is selected from a set of templates based on the one or more data types. Here, each one of the set of templates specifies a visualization of information associated with the data item. A visualization is presented based on the template.

In various embodiments, additional systems and method for enhancing data consumption are disclosed. An indication of an interest in an item of a data feed by a consumer of the data feed is inferred. The inferring is based on an interpretation of an action of the consumer with respect to the item and the item includes information relating to a first person and a second person, the information having a particular context. Additional information about the first person and the second person is retrieved with respect to the particular context. A visualization of the information and the additional information is configured to be rendered on a display device of the consumer to facilitate a consumption of the data feed by the consumer.

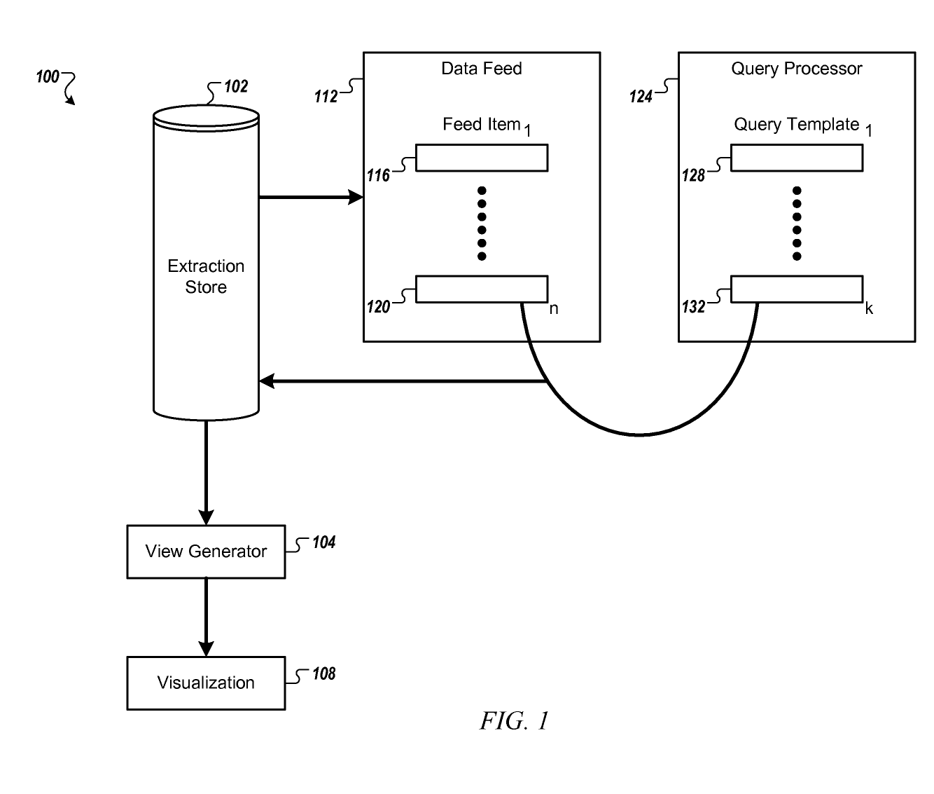

FIG. 1 is a block diagram depicting an example embodiment of a system 100 to enhance a consumption of a data feed. The system may include an Extraction Store 104 that includes a collection of structured data that represents events extracted from a stream of data feeds (e.g., news articles), a Query Processor (or Query System) 124 that enables users to generate data views based on items in the Extraction Store 104 (e.g., using a query language, such as the Structured Query Language (SQL)) and includes query template 1 128 through query template k 132, and a View Generator 104 that produces a visualization 108. The visualization may be a graphical representation of data. The data may be returned by a query issued to the Query Processor 124. For example, the visualization may be a diagram pertaining to a data item of a news feed. The visualization may be output from the View Generator 104, and a data feed 112, including feed item 1 116 through feed item n 120.

The Extraction Store 104 includes a collection of data amassed as a result of analyzing a continuous stream of one or more data feeds (e.g., a collection of news articles). The system 100 may extract data from the one or more data feeds. Additionally, the system 100 may organize or structure the data and store the organized or structured data in the Extraction Store 104. For example, the system 100 may extract from a data feed and store in the Extraction Store 104 one or more entities. Each of the entities may be a structure (e.g., an allocated space of memory, a data structure, or a pointer to a data structure) corresponding to portions of a data item of a data feed. Each entity may correspond to an entity type. The entity type may be a particular person, place, organization, context, or thing that has been identified or discussed with respect to the data item, or that is relevant to, or otherwise associated with, the data item. For example, the system 100 may identify an entity associated with a data item as having a context data type. Additionally, the system 100 may identify the entity (e.g., the context) as being a relationship (e.g., a friendship, professional, or romantic relationship) context, a location (e.g., geographic) context, or a financial (e.g., stock market) context. By design, the number of possible entity types may be unlimited. As another example, the system 100 may extract from a data feed and store in the Extraction Store 104 a collection of events that define (or name) an ordered relationship among entities found in the data. Each event in the Extraction Store 104 may contain a name that identifies the type of news item and a set of one or more ordered identifiers (IDs) corresponding to entries in the entity set. For example, the event represented as (dating, partner1=1911, partner2=4372) may indicate that entities 1911 and 4372 are believed to be dating one another.

Additionally, the Extraction Store 104 includes provenance information for data items (e.g., entities or events) that the system 100 extracts from one or more data feeds. The provenance information may include metadata associated with the data item. For example, an entry in the Extraction Store 104 corresponding to a data item may include a timestamp of the insertion of the extracted data item, the source of the insertion (e.g., the news article the item was extracted from), and a confidence measure reflecting the performance of the system 100. An external source (e.g., a data source or algorithm) may be responsible for posting entries to the Extraction Store 104. Each entry in the Extraction Store 104 may be associated with a score or a confidence measure that reflects a quality of the data based on one or more criteria. For example, the confidence measure may be based on a type of data source. In this case, an entry in the Extraction Store 104 that comes from a structured database (e.g., the Internet Movie Database (“IMDB”)) may have a higher confidence measure than an entry in the Extraction Store 104 that comes from an extraction by an algorithm from a textual source.

Regardless of whether the Extraction Store 104 is embodied using a relational database, key-value store, or other data-structure, the following properties of the data may be upheld (e.g., to ensure a clean user experience).

Each distinct entity may be referred to using a unique ID. For example, although news articles may refer to a particular entity using more than one form—e.g., “President Obama” and “Barack Obama” refer to the same person—the Extraction Store 104 may contain a single ID for this entity that absorbs both references. The ability to recognize multiple forms of a single entity may be implemented or enabled by a producer (or administrator) of the Extraction Store 104. The Extraction Store 104 may derive a single ID for an entity based on one or more string or attribute similarities contained in an external knowledge source. For example, the Extraction Store 104 may determine that, based on an entry in Wikipedia.org, that Alex Rodriguez is also known as A-Rod. The Extraction Store 104 may then use a single ID to refer to both Alex Rodriguez and A-Rod. Alternatively, the single ID may be specified by an administrator of the Extraction Store 104.

Each event type may be represented by a unique ID and may define one or more required entities of a given type. For example, a dating relationship may require two entities of type Person. Events and their entity/type requirements may be defined by the producer of the Extraction Store 104 and then exposed to the system 100.

Each event may be associated with one or more provenances. The presence of metadata for extracted events permits a user of the system 100 to explore the original sources that generated the feed items. For example, the user may be able to see the origin of the data feed item. Additionally, the user may be able to see context (e.g., a hyperlink pathway) that led to the generation of the data feed item.

The Query Processor 124 enables the system 100 to issue queries over data contained within the Extraction Store 104. The queries may be specified using a query language (e.g., SQL). As part of its implementation, the Query Processor 124 specifies a set of query templates (depicted in FIG. 1 as query template 1 128 through query template k 132) used to retrieve extractions that are subsequently rendered to the user. A query template may specify what data to retrieve relative to an input or the type of display to output (e.g., a graph, timeline, map, table, etc.).

The View Generator 104 utilizes a library of functions to transform a set of typed data output as a result of a query into a visualization 108 (e.g., a graphic that is displayed to the user).

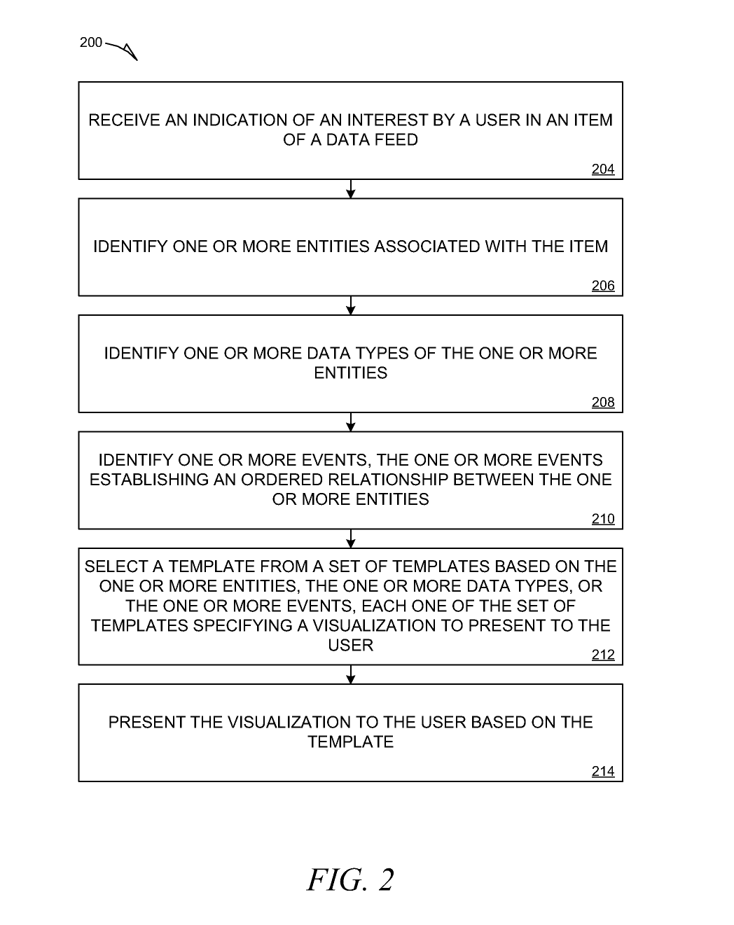

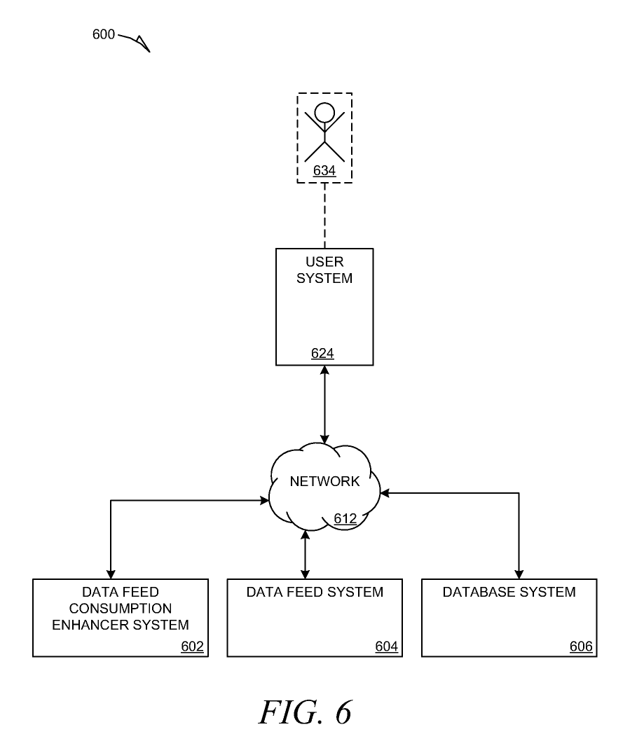

FIG. 2 is a flowchart of an example embodiment of a method 200 to enhance a consumption of a data feed. At operation 204, the Query Processor 124 receives an indication of an interest by a user in an item of a data feed (e.g., feed item 1 116 of data feed 112). The indication of the interest by the user (or consumer) of the data feed may be based on an action of the user with respect to the data feed. For example, the indication may be inferred from a selection by the user of the data item or a related data item with respect to a presentation of the data feed in a user interface (e.g., a web browser of the user system 624 of FIG. 6). At operation 206, the Query Processor 124 identifies one or more entities associated with the data item. At operation 208, the Query Processor 124 identifies one or more events, with the one or more events having an ordered relationship between them. At operation 210, the Query Processor 124 identifies one or more data types of the one or more entities. At operation 212, the Query Processor 124 selects a template (e.g., query template 1 128) from a set of templates based on the one or more entities, the one or more data types, or the one or more events. Each one of the set of templates may specify a visualization (e.g., a chart of additional data items) to present to the user. At operation 214, the View Generator 104 presents the visualization (e.g., visualization 108) based on the template. For example, the View Generator 104 operates on a definition of the visualization contained in the template to generate the visualization.

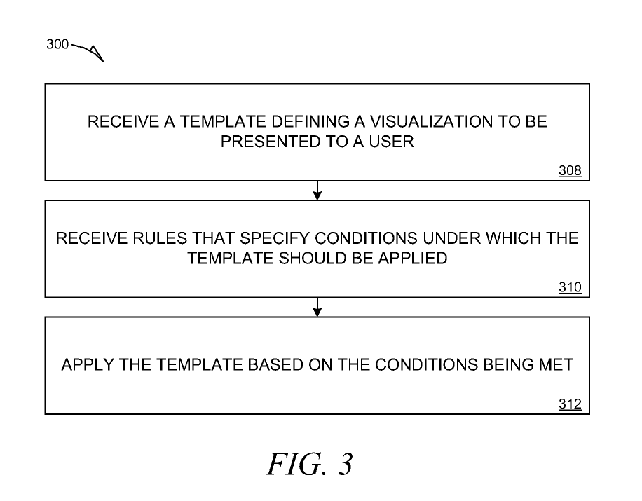

FIG. 3 is a flowchart of an example embodiment of a method 300 to enhance a consumption of a data feed. At operation 308, the Query Processor 124 receives a template defining a visualization to be presented to a user (e.g., the Query Processor 124 receives query template 1 128 from an administrator of system 100). At operation 310, the Query Processor 124 receives rules that specify conditions under which the template should be applied. At operation 312, the Query Processor 124 applies the template based on a determination that the conditions have been met.

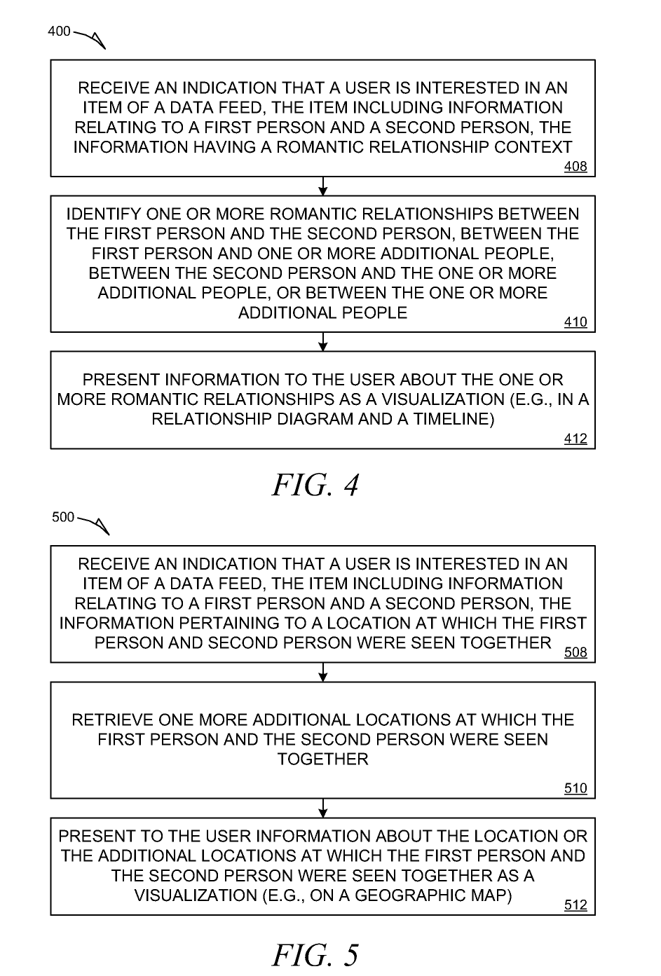

FIG. 4 is a flowchart of an example embodiment of a method 400 to enhance a consumption of a data feed. At operation 408, the Query Processor 124 receives an indication that a user is interested in an item of a data feed that relates to a first person and a second person, the information having a romantic relationship context. At operation 410, the Query Processor 124 identifies one or more dating relationships between the first person and the second person, between the first person and one or more additional people, between the second person and the one or more additional people, or between the one or more additional people (e.g., analyzing the data stored in the Extraction Store 104). At operation 412, the View Generator 104 presents the information about the one or more relationships to the user as a visualization (e.g., in a relationship diagram and a timeline).

FIG. 5 is a flowchart of an example embodiment of a method 500 to enhance a consumption of a data feed. At operation 508, the Query Processor 124 receives an indication that a user is interested in an item of a data feed that relates to a first person and a second person, the item pertaining to a location at which the first person and the second person were seen together. At operation 510, the Query Processor 124 retrieves (e.g., from the Extraction Store 104) one or more additional locations at which the first person and the second person were seen together. At operation 512, the View Generator 104 presents information about the location or the additional locations at which the first person and the second person were seen together (e.g., on a visualization on a geographic map).

Below are examples of query templates and rules that the system 100 may process. Given that an extraction takes the form (R, E1, . . . , En) where R is an event type and E1 . . .En are entities:

Given (R, X, Y) ̂ Timeline, retrieve O=(R, X, *) for display as timeline. Example: Given that person X has been observed to be dating person Y, obtain all people X has dated (e.g., X's dating history). (The asterisk (*) represents a wild card.)

Given (R, X, Y)d̂ Graph, retrieve O=(R, X, *) up to d times for each y∈* for display as graph. Example: Given that person X has been observed to be dating person Y, obtain the network of people who have dated one another beginning with X for up to d steps.

Given (R, X, Y, Z) ̂ Map, where Z is of type Location, retrieve O=(R, X, Y, *) for display on map. Example: Given that person X was spotted with person Y in a location Z, retrieve all locations in which the pair has been recorded together.

Although various embodiments of the methods described herein are described as being implemented by particular systems or particular modules, one skilled in the art would understand that the methods described herein may be implemented by various other systems or various other modules having corresponding functions or capabilities.

FIG. 6 is a block diagram illustrating an example environment 600 in which a system to enhance the consumption of a data feed may execute. The environment 600 may include a data feed consumption enhancer system 602 (e.g., the system of FIG. 1), a data feed system 604, a database system 606, a user system 624, and a user 634. The data feed system 604 may retrieve or otherwise receive various types of input data (e.g., text, multimedia, images) corresponding to a variety of content (e.g., articles or publications, videos, audio clips, transaction data, data sets) from a variety of data sources. It is contemplated that the particular types of input data and content capable of being retrieved by the information retrieval system 604 should not be construed as limited to the examples discussed herein. In an example embodiment, the data feed consumption enhancer system 602, the data feed system 604, or the user system 624 may store and access data in database system 606. For example, the Extraction Store 102 of FIG. 1 may be implemented as or within database system 606. In other words, the data feed consumption enhancer system 602 may store and retrieve data from the database 606 that is related to particular items of a data feed for which user 634 indicates an interest.

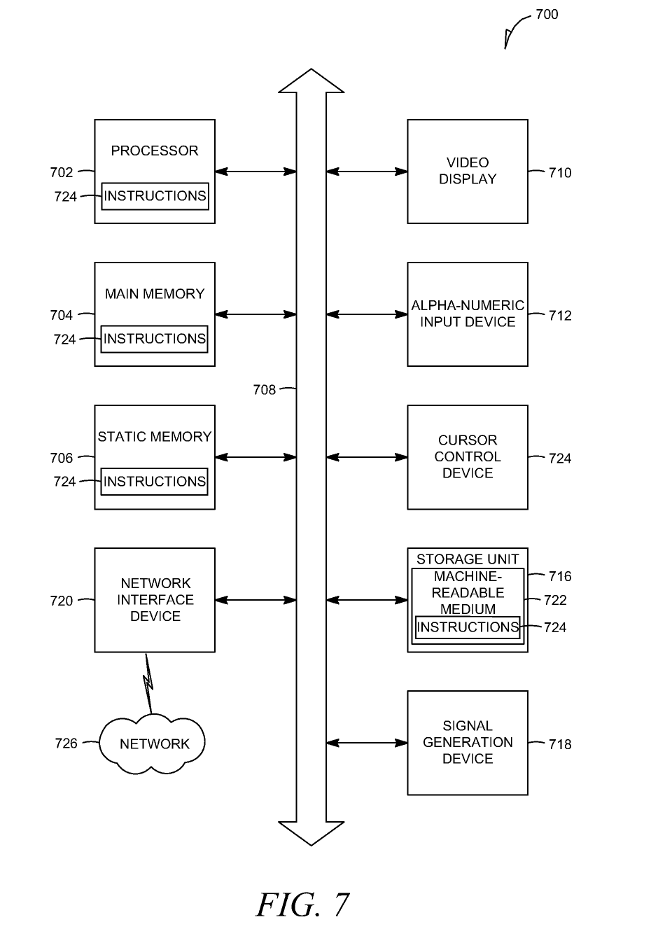

Any of the systems 602, 604, 606, 624 may be one or more machines (e.g., the machine of FIG. 7, discussed below). The user 634 may be a user of any of the systems 602, 604, 606, or 624. Additionally, the user 634 may be a person or a machine. The user system 624 may be associated with a display device on which visualizations associated with a data item of a data feed may be rendered after having been received from the data feed consumption enhancer system 602.

The user 634 may access the data feed consumption enhancer system 602 to facilitate or enhance a consumption of data from data feed system 604. The systems 602, 604, 606, and 624 may be connected via the network 612. For example, the user 634 may access a system (e.g., the data feed consumption enhancer system 602 or the data feed system 604) using a web browser application (e.g., Windows® Internet Explorer®) executing on a personal computer. In response, the user 634 may process data feeds more quickly (e.g., by viewing visualizations of data contained in the feed as well as additional information related to data contained in the feed.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 724 may further be transmitted or received over a communications network 726 using a transmission medium. The instructions 724 may be transmitted using the network interface device 720 and any one of a number of well-known transfer protocols (e.g., Hyper Text Transfer Protocol or HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. (canceled)

2. A computer-implemented method comprising:
receiving, by one or more processors, data indicating user interest of an item in a data feed;
identifying, by at least one of the processors, a first entity based on receiving the data indicating the user interest of the item in the data feed;
obtaining, by at least one of the processors and from one or more non-transitory storage devices, first data that references at least (i) a unique identifier associated with the first entity, (ii) a unique identifier associated with a second entity, and (iii) a particular relationship type for a relationship between the first entity and the second entity;
obtaining, by at least one of the processors and from at least one of the non-transitory storage devices, second data that references (i) the same unique identifier associated with the first entity, (ii) a unique identifier associated with a third entity, and (iii) the particular relationship type for a relationship between the first entity and the third entity;
selecting, by at least one of the processors, a particular summary representation template, from a set of templates, that defines a visualization to be presented in a user interface when a given entity, which is identified based on an indication of user interest of an item in a data feed, is related to two different entities through the same, particular relationship type in response to obtaining the first data that references the particular relationship type for a relationship between the first entity and the second entity, obtaining the second data that references the particular relationship type for a relationship between the first entity and the third entity, and receiving the data indicating the user interest of the item in the data feed;
applying, by at least one of the processors, the first data and the second data to the particular summary representation template to generate a visual summary representation that includes (i) a visual representation of the first entity, (ii) a visual representation of the second entity, and (iii) a visual representation of the third entity in response to selecting the particular summary representation template that defines the visualization to be presented in the user interface; and
providing, by at least one of the processors and for presentation in a user interface, the summary representation that includes (i) the representation of the first entity, (ii) the representation of the second entity, and (iii) the representation of the third entity in response to applying the first data and the second data to the particular summary representation template.

3. The computer-implemented method of claim 2, wherein receiving the data indicating user interest of the item in the data feed comprises receiving data indicating a user selection of the item in the data feed.

4. The computer-implemented method of claim 2, wherein providing, for presentation in the user interface, the summary representation that includes (i) the representation of the first entity, (ii) the representation of the second entity, and (iii) the representation of the third entity comprises providing, for presentation in the user interface, the summary representation that comprises a timeline that indicates i) a period of time in which the particular relationship type existed between the second entity and the first entity and ii) a period of time in which the particular relationship type existed between the third entity and the first entity in response to applying the first data and the second data to the particular summary representation template.

5. The computer-implemented method of claim 2, wherein providing, for presentation in the user interface, the summary representation that includes (i) the representation of the first entity, (ii) the representation of the second entity, and (iii) the representation of the third entity comprises providing, for presentation in the user interface, the summary representation that comprises a graph that indicates that (i) the particular relationship type existed between the first entity and the second entity, (ii) the particular relationship type existed between the first entity and the third entity, and (iii) a relationship type existed between a) second entity and a fourth entity or b) the third entity and the fourth entity in response to applying the first data and the second data to the particular summary representation template.

6. The computer-implemented method of claim 2, wherein providing, for presentation in the user interface, the summary representation that includes (i) the representation of the first entity, (ii) the representation of the second entity, and (iii) the representation of the third entity comprises providing, for presentation in the user interface, the summary representation that comprises a map that indicates one or more first geographic locations where the first entity and the second entity were located together and that indicates one or more second geographic locations where the first entity and the third entity were located together in response to applying the first data and the second data to the particular summary representation template.

7. (canceled)

8. The computer-implemented method of claim 2, wherein the particular relationship type between i) the first entity and the second entity or ii) between the first entity and the third entity indicates a dating or romantic relationship.

9. A non-transitory computer storage medium encoded with instructions that, when executed by a server, cause the server to perform operations comprising:
receiving data indicating user interest of an item in a data feed;
identifying a first entity based on receiving the data indicating the user interest of the item in the data feed;
obtaining first data that references at least (i) a unique identifier associated with the first entity, (ii) a unique identifier associated with a second entity, and (iii) a particular relationship type for a relationship between the first entity and the second entity;
obtaining second data that references (i) the same unique identifier associated with the first entity, (ii) a unique identifier associated with a third entity, and (iii) the particular relationship type for a relationship between the first entity and the third entity;
selecting a particular summary representation template, from a set of templates, that defines a visualization to be presented in a user interface when a given entity, which is identified based on an indication of user interest of an item in a data feed, is related to two different entities through the same, particular relationship type in response to obtaining the first data that references the particular relationship type for a relationship between the first entity and the second entity, obtaining the second data that references the particular relationship type for a relationship between the first entity and the third entity, and receiving the data indicating the user interest of the item in the data feed;
applying the first data and the second data to the particular summary representation template to generate a visual summary representation that includes (i) a visual representation of the first entity, (ii) a visual representation of the second entity, and (iii) a visual representation of the third entity in response to selecting the particular summary representation template that defines the visualization to be presented in the user interface; and
providing, for presentation in a user interface, the summary representation that includes (i) the representation of the first entity, (ii) the representation of the second entity, and (iii) the representation of the third entity in response to applying the first data and the second data to the particular summary representation template.

10. The computer storage medium of claim 9, wherein receiving the data indicating user interest of the item in the data feed comprises receiving data indicating a user selection of the item in the data feed.

11. The computer storage medium of claim 9, wherein providing, for presentation in the user interface, the summary representation that includes (i) the representation of the first entity, (ii) the representation of the second entity, and (iii) the representation of the third entity comprises providing, for presentation in the user interface, the summary representation that comprises a timeline that, for each of the second entity and the third entity, indicates a period of time in which relationship type existed between the entity and the first entity in response to applying the first data and the second data to the particular summary representation template.

12. The computer storage medium of claim 9, wherein providing, for presentation in the user interface, the summary representation that includes (i) the representation of the first entity, (ii) the representation of the second entity, and (iii) the representation of the third entity comprises providing, for presentation in the user interface, the summary representation that comprises a graph that indicates that (i) the relationship type existed between the first entity and the second entity, (ii) the relationship type existed between the first entity and the third entity, and (iii) the relationship type existed between second entity or the third entity and a fourth entity in response to applying the first data and the second data to the particular summary representation template.

13. The computer storage medium of claim 9, wherein providing, for presentation in the user interface, the summary representation that includes (i) the representation of the first entity, (ii) the representation of the second entity, and (iii) the representation of the third entity comprises providing, for presentation in the user interface, the summary representation that comprises a map that indicates one or more first geographic locations where the first entity and the second entity were located together and that indicates one or more second geographic locations where the first entity and the third entity were located together in response to applying the first data and the second data to the particular summary representation template.

14. (canceled)

15. The computer storage medium of claim 9, wherein the relationship type indicates a dating or romantic relationship.

16. A system comprising:
a database storing data representing a plurality of entities, a unique identifier for each of the entities, and relationships between some of the entities;
a server; and
one or more non-transitory storage devices storing instructions that are operable, when executed by the server, to cause the server to perform operations comprising:
receiving data indicating user interest of an item in a data feed;
identifying a first entity based on receiving the data indicating the user interest of the item in the data feed;
obtaining, from the database, first data that references at least (i) a unique identifier associated with the first entity from the entities, (ii) a unique identifier associated with a second entity from the entities, and (iii) a particular relationship type for a relationship between the first entity and the second entity;
obtaining, from the database, second data that references (i) the same unique identifier associated with the first entity, (ii) a unique identifier associated with a third entity from the entities, and (iii) the particular relationship type for a relationship between the first entity and the third entity;
selecting a particular summary representation template, from a set of templates, that defines a visualization to be presented in a user interface when a given entity, which is identified based on an indication of user interest of an item in a data feed, is related to two different entities through the same, particular relationship type in response to obtaining the first data that references the particular relationship type for a relationship between the first entity and the second entity, obtaining the second data that references the particular relationship type for a relationship between the first entity and the third entity, and receiving the data indicating the user interest of the item in the data feed;
applying the first data and the second data to the particular summary representation template to generate a visual summary representation that includes (i) a visual representation of the first entity, (ii) a visual representation of the second entity, and (iii) a visual representation of the third entity in response to selecting the particular summary representation template that defines the visualization to be presented in the user interface; and
providing, for presentation in a user interface, the summary representation that includes (i) the representation of the first entity, (ii) the representation of the second entity, and (iii) the representation of the third entity in response to applying the first data and the second data to the particular summary representation template.

17. The system of claim 16, wherein receiving the data indicating user interest of the item in the data feed comprises receiving data indicating a user selection of the item in the data feed.

18. The system of claim 16, wherein providing, for presentation in the user interface, the summary representation that includes (i) the representation of the first entity, (ii) the representation of the second entity, and (iii) the representation of the third entity comprises providing, for presentation in the user interface, the summary representation that comprises a timeline that, for each of the second entity and the third entity, indicates a period of time in which relationship type existed between the entity and the first entity in response to applying the first data and the second data to the particular summary representation template.

19. The system of claim 16, wherein providing, for presentation in the user interface, the summary representation that includes (i) the representation of the first entity, (ii) the representation of the second entity, and (iii) the representation of the third entity comprises providing, for presentation in the user interface, the summary representation that comprises a graph that indicates that (i) the relationship type existed between the first entity and the second entity, (ii) the relationship type existed between the first entity and the third entity, and (iii) the relationship type existed between second entity or the third entity and a fourth entity in response to applying the first data and the second data to the particular summary representation template.

20. The system of claim 16, wherein providing, for presentation in the user interface, the summary representation that includes (i) the representation of the first entity, (ii) the representation of the second entity, and (iii) the representation of the third entity comprises providing, for presentation in the user interface, the summary representation that comprises a map that indicates one or more first geographic locations where the first entity and the second entity were located together and that indicates one or more second geographic locations where the first entity and the third entity were located together in response to applying the first data and the second data to the particular summary representation template.

21. (canceled)

22. The method of claim 2 comprising:
receiving data from a data feed;
extracting a subset of data from the data;
determining that the subset of data identifies the first entity; and
associating, in a database, the subset of data with the first entity.

23. The method of claim 22 wherein associating, in the database, the subset of data with the first entity comprises storing the subset of data and the unique identifier for the first entity in a record in the database.

24. The method of claim 22 comprising:
determining that the subset of data identifies the second entity;
determining, using the subset of data, the particular relationship type for the relationship between the first entity and the second entity;
associating, in the database, the subset of data with the second entity; and
associating, in the database, the subset of data with the particular relationship type.

25. (canceled)

26. The computer storage medium of claim 9 the operations comprising:
receiving data from a data feed;
extracting a subset of data from the data;
determining that the subset of data identifies the first entity; and
associating, in a database, the subset of data with the first entity.

27. The computer storage medium of claim 26 wherein associating, in the database, the subset of data with the first entity comprises storing the subset of data and the unique identifier for the first entity in a record in the database.

28. The computer storage medium of claim 26 the operations comprising:
determining that the subset of data identifies the second entity;
determining, using the subset of data, the particular relationship type for the relationship between the first entity and the second entity;
associating, in the database, the subset of data with the second entity; and
associating, in the database, the subset of data with the particular relationship type.
